(19) United States
(12) Patent Application Publication
(10) Pub. No.: US 2018/0345404 A1
(43) Pub. Date: Dec. 6, 2018

(54) LASER PROCESSING DEVICE, LASER PROCESSING METHOD, OPTICAL SYSTEM, AND CLADDED ARTICLE

(71) Applicants: KABUSHIKI KAISHA TOYOTA CHUO KENKYUSHO, Nagakute-shi, Aichi (JP); TOYOTA JIDOSHA KABUSHIKI KAISHA, Toyota-shi, Aichi (JP)

(72) Inventors: Kazuo HASEGAWA, Nagakute-shi (JP); Satoru KATO, Nagakute-shi (JP); Chie TOYODA, Nagakute-shi (JP); Tomoya OKAZAKI, Ena-shi (JP); Yoshinori SHIBATA, Nagoya-shi (JP); Yuta FUJIKASA, Nagoya-shi (JP)

(73) Assignees: KABUSHIKI KAISHA TOYOTA CHUO KENKYUSHO, Nagakute-shi, Aichi (JP); TOYOTA JIDOSHA KABUSHIKI KAISHA, Toyota-shi, Aichi (JP)

(21) Appl. No.: 15/778,539

(22) PCT Filed: Oct. 27, 2016
(86) PCT No.: PCT/JP2016/081941

§ 371 Date: May 23, 2018

(30) Foreign Application Priority Data
Dec. 22, 2015 (JP) 2015-249409

(51) Int. Cl. B23K 26/067; B23K 26/06; G02B 27/30; B23K 26/00

(52) U.S. Cl. CPC B23K 26/067; B23K 26/0648; B23K 26/0006; G02B 27/30; B23K 26/0643

(57) ABSTRACT

A laser processing device includes: a laser source; a collimator that collimates light generated by the laser source; an optical element including a converter that converts the collimated light into a beam of light that includes a plurality of collimated lights which respectively have optical axes that are different from each other and that transmits the beam of light; and a focusing element that focuses the beam of light onto a workpiece.

### TECHNICAL FIELD

The present invention relates to a laser processing device, a laser processing method, an optical system, and a cladded article.

### BACKGROUND ART

Laser processing devices are a type of device for processing workpieces. Laser processing devices can be used to perform a variety of processes, such as drilling, cutting, welding, hardening, and cladding, on workpieces made of metal or the like. Various considerations are made depending on the specifics of the processing being performed, such as to the laser beam profile (optical intensity distribution, energy density) of a laser source employed by the laser processing device in the vicinity of a processing point and the method of shaping the laser beam.

One known laser processing device scans laser light emitted from a laser source over a workpiece using a galvano scanner so as to perform a desired process on the workpiece. The galvano scanner includes a galvano mirror that reflects focused laser light emitted from the laser source, and a galvano motor with a drive shaft attached to the galvano mirror. The galvano motor is driven to move the galvano mirror back and forth, thereby scanning laser light reflected by the galvano mirror over the workpiece. In such a laser processing device, for example, the workpiece is moved relative to the galvano mirror along a direction substantially orthogonal to the back and forth movement of the galvano mirror as processing proceeds (for example, see Japanese Patent Application Laid-Open (JP-A) No. S62-016894).

Known related art concerning laser beam profiles includes the laser processing device disclosed in Japanese Patent No. 5595573. The laser processing device disclosed in Japanese Patent No. 5595573 includes a solid-state laser oscillator that outputs a laser, and an optical system that focuses the laser output from the solid-state laser oscillator and irradiates the laser onto the workpiece. The solid-state laser oscillator outputs a laser wherein, in a cross-section through the center of the laser along its direction of travel, the beam profile of the laser is shaped such that plural peaks are formed at the outsides of the center of the laser, and the output at these peaks is higher than at the center of the laser. The optical system irradiates the laser onto the workpiece in a state in which the position of its focal point is offset from the processing position on the workpiece.

As a result of this configuration, in the laser processing device disclosed in Japanese Patent No. 5595573, the laser irradiated onto the workpiece is able to have a distribution where output is stronger at the sides of a region where the laser is irradiated, enabling a stronger laser to be irradiated at the edges of a region of the workpiece being processed and enabling processing to be performed with higher precision.

One processing method that utilizes the special features of laser processing is cladding. In a cladding process, a material differing from that of a base material is melted and solidified onto a predetermined portion of the base material so as to increase surface strength or wear resistance at the predetermined portion of the base material. In laser processing, a laser source is employed as a heat source for such cladding.

Another known laser processing device is the laser processing device disclosed in Japanese Patent No. 3232940, a document disclosing a laser processing device for cladding. In the laser processing device disclosed in Japanese Patent No. 3232940, a predetermined amount of a copper-based alloy powder is continuously supplied to a valve seat of a cylinder head and a laser beam that has been formed into a line by a concave cylindrical mirror and an integrated mirror provided with narrow, flat-faced mirror segments is irradiated onto the copper-based alloy powder from above while the valve seat is being rotationally fed, thereby forming a copper-based alloy cladding layer on the valve seat. As a result of this configuration in the laser processing device disclosed in Japanese Patent No. 3232940, since the energy density characteristics of the line-shaped laser beam are substantially uniform across a width direction of the cladding, the amount of heat input is not liable have local variation along the cladding width direction, enabling the formation of a good cladding layer that in particular is not locally diluted with the base material along the cladding width direction.

### SUMMARY OF INVENTION

### Technical Problem

However, in laser processing, the desired beam profile for a laser source employed in laser processing differs depending on, for example, processing specifics, the workpiece, and the profile of heat input (the amount of external heat applied in the vicinity of a processing point during processing) to the workpiece. It is thus desirable to be able to flexibly modify the beam profile, namely the optical intensity distribution, of the laser source in the vicinity of the processing point.

Regarding this point, a laser processing device such as disclosed in JP-A No. S62-016894 is not suited for control of the optical intensity distribution of the laser beam due to being configured to move a spot-focused laser beam back and forth along a direction substantially orthogonal to the direction processing proceeds using a galvano mirror. Moreover, this laser processing device has inferior reliability due to including moving parts such as the rotating parts of the galvano motor and the galvano mirror, and is additionally disadvantaged by the high cost of the galvano mirror itself.

In the laser processing device disclosed in Japanese Patent No. 5595573, although defocusing the focal point of the laser beam modifies the optical intensity distribution, in such a method there is a limit to the range of movement along the direction of the optical axis for modifying the optical intensity distribution, and so there is the issue that the range of variation for the optical intensity distribution is narrow.

The laser processing device disclosed in Japanese Patent No. 3232940 is specialized for a cladding process and employs a particular optical system combining a concave cylindrical mirror and an integrated mirror to achieve uniformity in its optical intensity distribution, and is not compatible with an optical intensity distribution that flexibly changes. Moreover, the laser processing device disclosed in Japanese Patent No. 3232940 is a reflection-type laser processing device. The device is therefore large and disadvantaged by a commensurate increase in cost.

In consideration of the above circumstances, an object of the present invention is to provide a laser processing device with which an optical intensity distribution at a processing point can be flexibly modified with a simple configuration, and that is able to easily control heat input to a workpiece.

### Solution to Problem

A first aspect of the present invention is a laser processing device that includes: a laser source; a collimator that collimates light generated by the laser source; an optical element including a converter that converts the collimated light into a beam of light that includes a plurality of collimated lights which respectively have optical axes that are different from each other and that transmits the beam of light; and a focusing element that focuses the beam of light onto a workpiece.

A second aspect of the present invention is the first aspect of the laser processing device, wherein: the converter of the optical element has a wedge shape that has at least two faces, and the converter is disposed within the collimated light so that a ridge line of the wedge shape faces toward the laser source.

A third aspect of the present invention is the first aspect of the laser processing device, wherein: the converter of the optical element has a conical shape, and the converter is disposed within the collimated light so that an apex of the conical shape faces toward the laser source.

A fourth aspect of the present invention is any of the first to the third aspects of the laser processing device, that further includes: a cladding section including a cladding material supply portion that supplies cladding material for a cladding process, wherein the cladding section performs the cladding process by supplying the cladding material to the workpiece from the cladding material supply portion and irradiating the beam of light onto the supplied cladding material while the cladding material supply portion and the beam of light move relative to the workpiece.

A fifth aspect of the present invention is the fourth aspect of the laser processing device, wherein: the cladding section performs the cladding process to form a valve seat of a cylinder head for an internal combustion engine.

A sixth aspect of the present invention is an optical system that includes: a collimator that collimates light generated by a light source; an optical element that converts the collimated light into a beam of light that includes a plurality of collimated lights that respectively have optical axes that are different from each other and that transmits the beam of light; and a focusing element that focuses the beam of light.

A seventh aspect of the present invention is a laser processing method that includes: collimating light generated by a laser source using a collimator; converting the collimated light into a beam of light that includes a plurality of collimated lights that respectively have optical axes that are different from each other, and transmitting the beam of light, using an optical element; and focusing the beam of light onto a workpiece using a focusing element.

A eighth aspect of the present invention is the seventh aspect of the laser processing method, that further includes: using a cladding section including a cladding material supply portion that supplies cladding material for a cladding process, and performing the cladding process by supplying the cladding material to the workpiece from the cladding material supply portion while moving the cladding material supply portion and the beam of light relative to the workpiece and irradiating the beam of light onto the supplied cladding material.

A ninth aspect of the present invention is a cladded workpiece that includes: a base material that is composed of a first metal; a cladded portion that is formed on the base material using a second metal; and an alloy portion that is disposed between the base material and the cladded portion, where the base material and the cladded portion are melted and bonded together, wherein: a bonding face between the base material and the alloy portion is bowl shaped, and the cladded portion and the alloy portion are formed via a cladding process in which, in a case in which a cladding material is supplied to the base material, collimated light obtained from light generated by a laser source is converted by an optical element into a beam of light that includes a plurality of collimated lights that respectively have optical axes that are different from each other, the beam of light is focused onto a workpiece by a focusing element, and the beam of light is irradiated onto the supplied cladding material.

### Advantageous Effects of Invention

The present invention has the advantageous effect of enabling a laser processing device to be provided with which an optical intensity distribution at a processing point can be flexibly modified with a simple configuration, and that is able to easily control heat input to a workpiece.

### BRIEF DESCRIPTION OF DRAWINGS

FIG. 1A is a diagram illustrating an example configuration of a laser processing device according to a first exemplary embodiment, and FIG. 1B and FIG. 1C are diagrams illustrating an example of an optical element.

FIG. 2A is a graph illustrating an example optical intensity distribution at a processing point for a laser source according to the first exemplary embodiment, and FIG. 2B is a diagram to explain the shape of the optical element.

FIG. 3A is a diagram illustrating an example of a processing method using a laser processing device according to the first exemplary embodiment, and FIG. 3B is a diagram illustrating a processing method using a laser processing device according to related art.

FIG. 4A and FIG. 4B are diagrams illustrating an example configuration of a laser processing device according to a second exemplary embodiment.

FIG. 5A is a diagram illustrating a cylinder head, and FIG. 5B is a diagram to explain the manufacturing of a valve seat cladded using a laser processing device according to the second exemplary embodiment.

FIG. 6A is a diagram to explain a portion cladded using a laser processing device according to the second exemplary embodiment, and FIG. 6B is a diagram to explain a portion cladded according to related art.

### DESCRIPTION OF EMBODIMENTS

Detailed explanation follows regarding exemplary embodiments of the present invention, with reference to the drawings.

### First Exemplary Embodiment

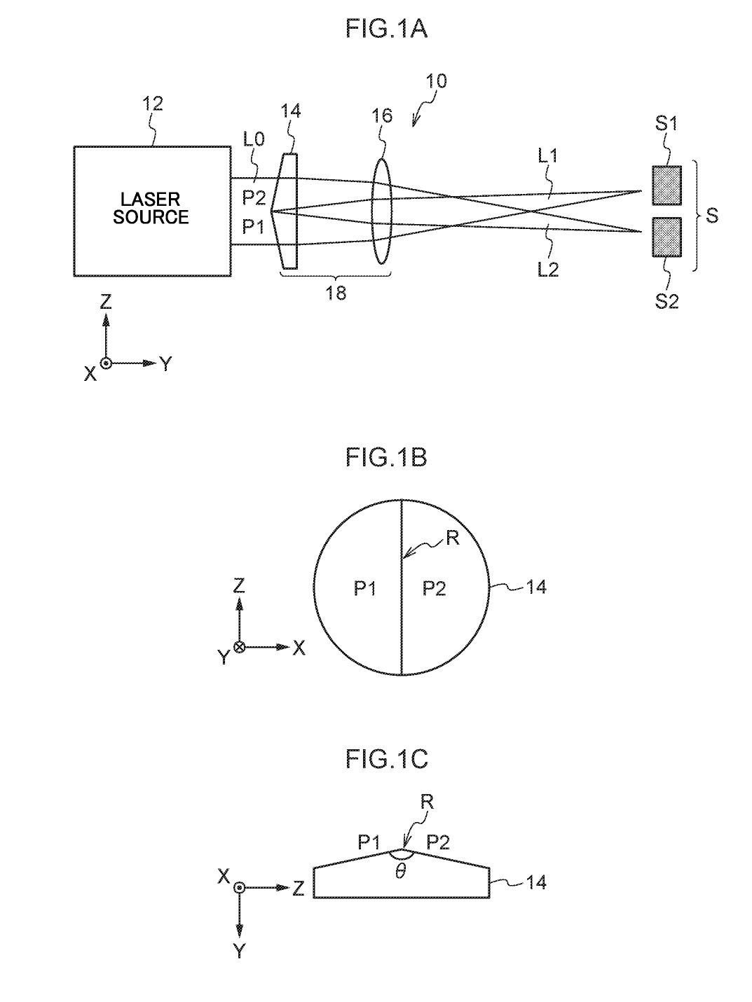

Explanation follows regarding a laser processing device 10 according to the present exemplary embodiment, with reference to FIG. 1A to FIG. 3B.

As illustrated in FIG. 1A, the laser processing device 10 is configured including a laser source 12, an optical element 14, and a lens 16.

The laser source 12 is a heat source for supplying heat during processing, and in the present exemplary embodiment is configured using a semiconductor laser. A non-illustrated collimator lens is built into the laser source 12. The laser source 12 outputs light emitted from the semiconductor laser as collimated light L0. The semiconductor laser configuring the laser source 12 may be a single semiconductor laser, or may be an array of semiconductor lasers arranged having plural points of light emission.

Note that although a semiconductor laser is given as an example of the laser source 12 in the present exemplary embodiment, there is no limitation thereto, and another kind of laser source may be employed. For example, a Nd:YAG (neodymium-doped yttrium aluminum garnet) solid-state laser, a fiber laser, or a fiber-transmitted laser (a light source where the output of a solid-state laser or the output of a semiconductor laser is transmitted by an optical fiber) may be employed.

The optical element 14 according to the present exemplary embodiment is an element that converts the optical axis of the collimated light L0 to modify the beam profile of the laser source 12. As illustrated in FIG. 1B, the optical element 14 according to the present exemplary embodiment has a substantially circular outer profile and is configured by a material that is transparent to the wavelength of the laser source 12, for example, quartz. As illustrated in FIG. 1C, one of the sides of the optical element 14 is wedge shaped, and includes a face P1, a face P2, and a ridge line R. In the present exemplary embodiment, the ridge line R is disposed at the center of the outer profile of the optical element 14, the face P1 and the face P2 are configured with identical shapes (namely, with left-right symmetry), and the face P1 and the face P2 are disposed with a vertex angle θ formed therebetween.

The ridge line R of the optical element 14 is disposed pointing toward the collimated light L0, thereby converting the optical axis of the collimated light L0 so as to be angled inward. Namely, as illustrated in FIG. 1A, the optical axis of light transmitted through the face P1 is bent in the +Z direction, and the optical axis of light transmitted through the face P2 is bent in the −Z direction. In other words, the optical element 14 is an element that converts the optical path of collimated light L0 with a substantially uniform optical intensity distribution and changes the optical intensity distribution (imparts a bias to the optical intensity distribution). Note that in the following explanation, the terms “beam profile” and “energy density” are both used to mean the same thing as “optical intensity distribution”.

The lens 16 is an element that focuses light on the workpiece after the light has been transmitted through the optical element 14 and had its optical axis converted. Together with the optical element 14, the lens 16 configures an optical system 18 according to the present exemplary embodiment.

Light transmitted through the face P1 of the optical element 14 is focused by the lens 16 so as to form a beam of light L1, and light transmitted through the face P2 is focused by the lens 16 so as to form a beam of light L2. As a result, the focus (image point) of the laser light according to the present exemplary embodiment, or the shape of a spot S in the vicinity thereof in the Y-axis direction, has a shape extended in both Z-axis directions, and for example, as illustrated in FIG. 1A, is shaped split into a spot S1 and a spot S2. By thus giving the spot S a shape extended along the direction of the Z-axis or a shape split into two in the present exemplary embodiment, optical intensity decreases along a line at a central portion of the spot S, making it possible for laser light power to not be concentrated at the central portion of the spot S.

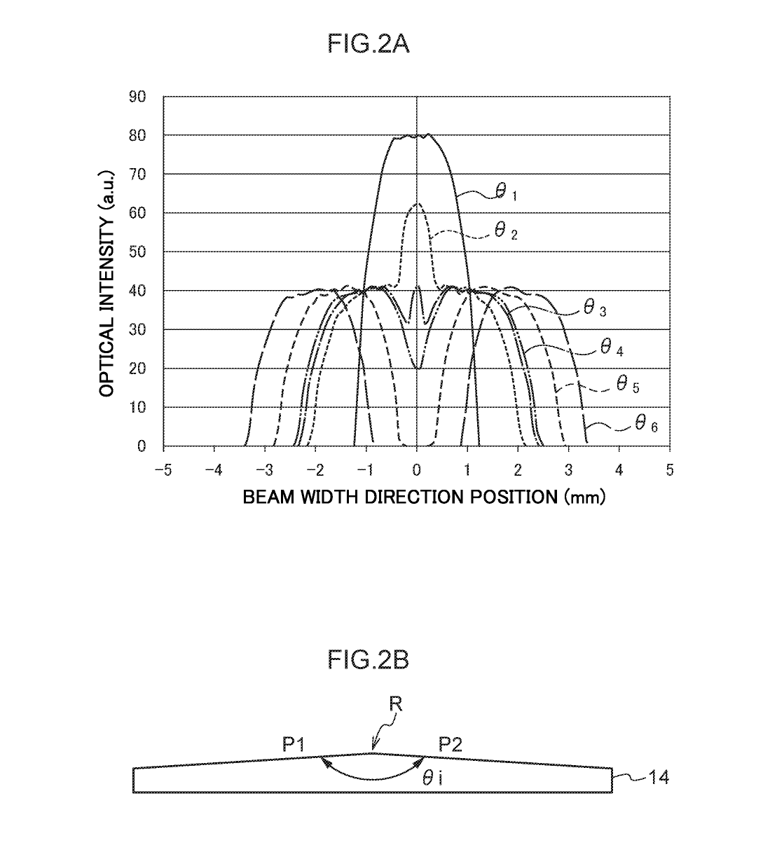

The optical intensity at the central portion of the spot S, namely, the degree of separation between the spot S1 and the spot S2, can be modified by changing the vertex angle θ of the optical element 14. Explanation follows regarding the relationship between vertex angle θ and the optical intensity distribution at the spot S, with reference to FIG. 2A and FIG. 2B. FIG. 2A illustrates optical intensity distributions at the spot S predicted using ray-tracing resulting from varying the vertex angle θi (i=1 to 6) of the wedge shaped optical element 14 illustrated in FIG. 2B. Experimental results closely match the results illustrated in FIG. 2A. Note that for these experiments, quartz substrates approximately 5 mm thick were used to manufacture the optical elements 14.

FIG. 2A illustrates optical intensity distributions at the spot S for six vertex angles θi (θ1 to θ6) of the optical element 14 (θ1>θ2>θ3>θ4>θ5>θ6, θ1<180°). In FIG. 2A, the width direction (the Z-axis direction in FIG. 1A) position (in mm) of each beam is indicated by the horizontal axis, the optical intensity of each beam (arbitrarily scaled) is indicated by the vertical axis, and the angular width from θ1 to θ6 (θ1-θ6) is in an approximate range of from 2° to 3°.

As illustrated in FIG. 2A, when the vertex angle is θ1, which is approximately 180°, namely when the optical element 14 is simply a flat, transparent substrate, the spot S has a unimodal shape with a maximum width of approximately 2.5 mm. Namely, the optical intensity distribution at the spot S when the optical element 14 in FIG. 1A is removed is substantially the same as the optical intensity distribution illustrated for θ1 in FIG. 2A.

As illustrated in FIG. 2A, when the vertex angle Oi is gradually reduced from θ1, the peak value of the optical intensity distribution first decreases by approximately half (when θi=θ3, θi=θ2, the optical intensity at the shoulders is decreased by approximately half), and the width of the beam approximately doubles. At the same time, the optical intensity at the central portion of the spot S (the portion near where the beam width direction position is 0 in FIG. 2A) starts to drop (θi=θ3, θ4), and when θi=θ5 the spot S splits into the two spots S1, S2. In other words, the optical system 18 operates so as to enable the modification of optical intensity along a line parallel to the Y-axis direction illustrated in FIG. 1A at the central portion of the spot S of the laser light. Accordingly, it is possible to modify optical intensity distribution along a direction intersecting (orthogonal to) the direction processing proceeds when the spot S and the workpiece are moved relative to one another along the Y-axis direction illustrated in FIG. 1A to advance processing.

Thus, configuration of the laser processing device 10 according to the present exemplary embodiment is such that the optical intensity distribution, namely the energy density, at the spot S at the processing point, and in the vicinity of the processing point, on the workpiece is able to be flexibly modified by operation of the optical system 18. This enables choosing the most appropriate optical intensity distribution for obtaining a heat input distribution at the processing point corresponding to, for example, the specifics of processing to be performed using the laser processing device 10.

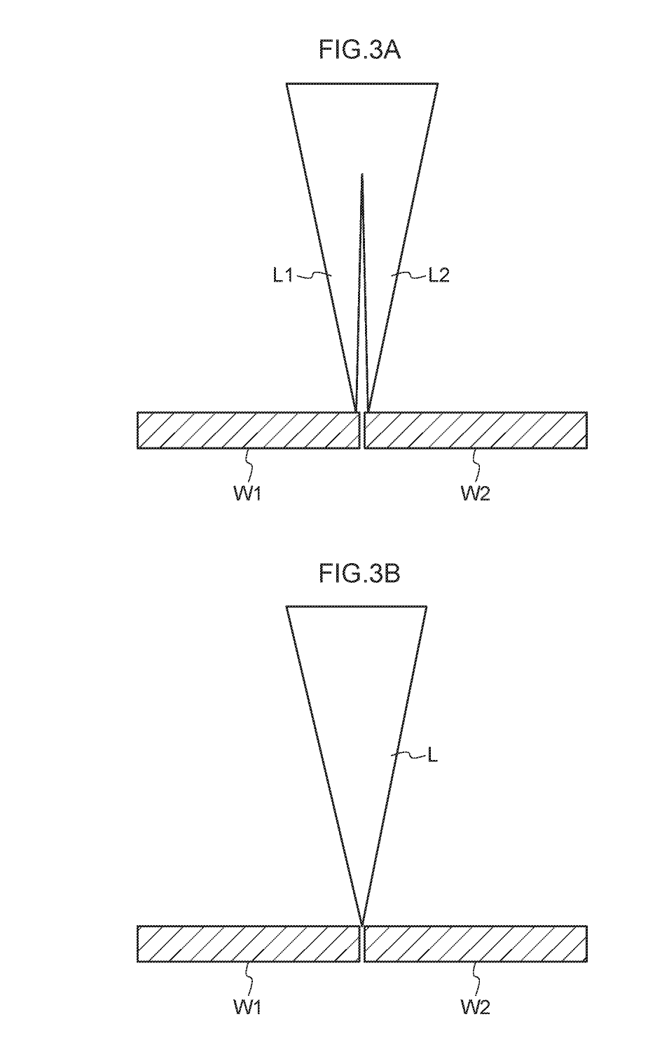

Explanation follows regarding an example of processing using the laser processing device 10 according to the present exemplary embodiment, with reference to FIG. 3A and FIG. 3B. FIG. 3A and FIG. 3B are processing examples for when two workpieces W1 and W2 are butt welded. Note that the workpieces W1, W2 in FIG. 3A and FIG. 3B are, for example, steel sheets.

FIG. 3B illustrates a situation in which a laser processing device according to related art is used in butt-joining.

As illustrated in FIG. 3B, with the laser processing device according to the related art, a single beam of light L from a laser source is irradiated onto separate workpieces W1 and W2. It is therefore difficult to simultaneously establish an appropriate positional relationship for both the positional relationship between the beam of light L and an end of the workpiece W1 and the positional relationship between the beam of light L and an end of the workpiece W2. Thus, for example, since the end of the workpiece W1 and the end of the workpiece W2 are butt-joined in a state having differing degrees of melting, energy efficiency cannot necessarily be said to be good.

In contrast to the related art, with the laser processing device 10 according to the present exemplary embodiment, it is possible to respectively irradiate a beam of light L1 and a beam of light L2 that have been split apart onto the workpiece W1 and the workpiece W2. Namely, the beam of light L1 is able to be respectively irradiated onto the end of the workpiece W1, and the beam of light L2 is able to be respectively irradiated onto the end of the workpiece W2. The distance between the beams of light L1 and L1 when being irradiated can be adjusted via the vertex angle θ of the optical element 14. The workpiece W1 and the workpiece W2 are therefore able to be butt-joined in a state in which the degree of melting of the end of the workpiece W1 and the degree of melting of the workpiece W2 are substantially the same. This enables butt-joining with good energy efficiency, and has the advantageous effect of also reducing the amount of time needed for melting, etc.

### Second Exemplary Embodiment

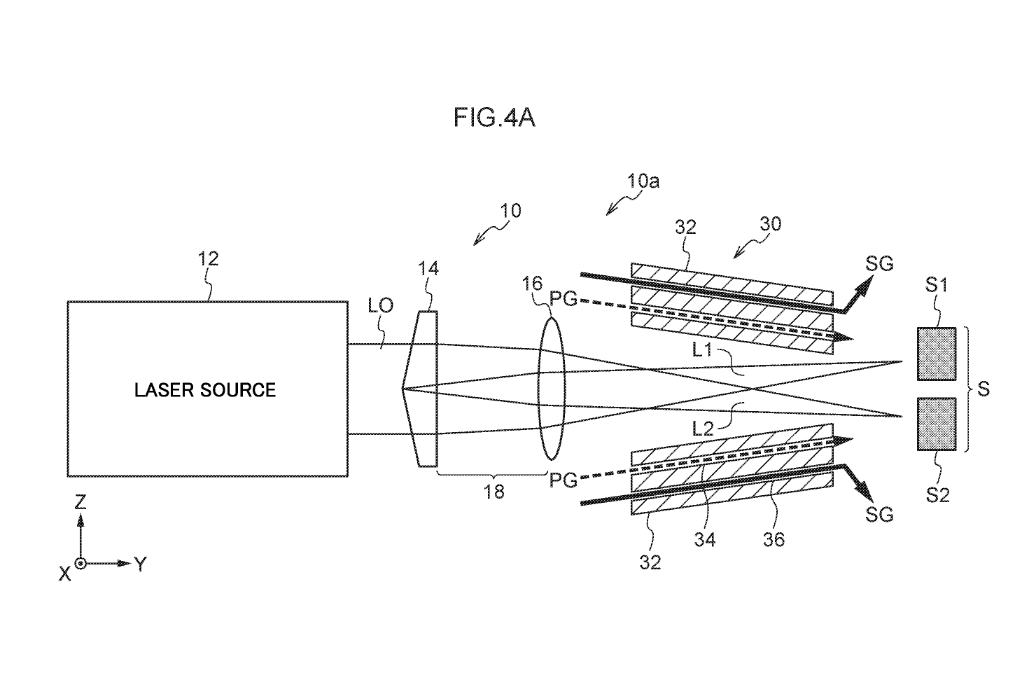

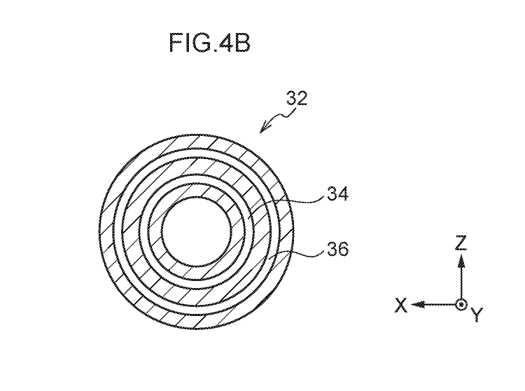

Explanation follows regarding a laser processing device 10a according to the present exemplary embodiment, with reference to FIG. 4A to FIG. 6B.

The laser processing device 10a is a laser processing device according to the present exemplary embodiment applied to a cladding process. As illustrated in FIG. 4A, the laser processing device 10a is the laser processing device 10 described above additionally provided with a metal powder supply mechanism 30 for performing the cladding process. Since the laser processing device 10 configured including the laser source 12, the optical element 14, and the lens 16 is the same as the laser processing device 10 according to the exemplary embodiment described above, detailed explanation thereof will not be given.

The metal powder supply mechanism 30 is configured including a nozzle 32, a metal powder source and a conveyor therefor, a conveyance gas and a conveyor therefor, and a shielding gas and a conveyor therefor, none of which are illustrated in the drawings.

As illustrated in FIG. 4A, the nozzle 32 includes a metal powder/conveyance gas flow path 34 and a shielding gas flow path 36. The metal powder/conveyance gas flow path 34 is for supplying metal powder, serving as a cladding material, and conveyance gas (for example, nitrogen gas) as a powder-mixed gas PG The shielding gas flow path 36 supplies shielding gas SG (for example, nitrogen gas) for shielding a location being worked on from the exterior when performing the cladding process. As illustrated in FIG. 4B, as viewed along the +Y direction, the metal powder/conveyance gas flow path 34 and the shielding gas flow path 36 are concentrically disposed in the nozzle 32. In the laser processing device 10a, the cladding process is performed by ejecting metal powder from the nozzle 32 as the beams of light L1, L2 are irradiated onto a processing point. As this happens, the shielding gas SG shields the work location where the cladding process is being performed such that the area around the work location is kept within an environment of conveyance gas.

In the cladding process, a material (cladding material) supplied in the form of a powder or a wire, for example, is melted onto the surface of a base material so as to be bonded thereto. It is preferable that the energy density at the spot S during the cladding process be of a level sufficient to melt the cladding material, suppress the amount of heat input to the maximum extent possible, and minimize the size of a heat-affected zone (a region affected by input heat when heat is input) (minimize distortion of the base material due to heat input). Further, in cladding processes, the diffusion of melted base material into the cladding material, a phenomenon known as dilution, inevitably occurs although the degree of this may vary. Issues may occur when the diffusion of the base material becomes excessive and the range of the diluted area becomes large, for example cracking may arise at the cladded portion, and the properties of the cladded portion may suffer such that the cladded portion hardens and becomes brittle.

On this point, with regards to the energy density at the spot S for the laser processing device according to the related art not employing the optical element 14, the energy of the laser source is generally concentrated at the central portion of the spot S, as illustrated by θ1 in FIG. 2A. The energy density at the spot S according to the related art does not necessarily match the energy density appropriate for a cladding process that requires an energy density such as that described earlier. Further, although related art exists in which the optical intensity distribution at the spot S is made uniform, even when such an optical intensity distribution is applied, there is still a tendency for the central portion to become overheated.

In the laser processing device 10a according to the present exemplary embodiment, the optical system 18 is operated to adjust the energy density at the spot S at the processing point and in the vicinity of the processing point so as to be most suited to the cladding process. More specifically, the laser processing device 10a is configured such that by suppressing the energy density near the center of the spot S, namely, by scattering the energy near a center line toward both sides, the heat input distribution at the processing point and in the vicinity of the processing point is made uniform. This moderates heat concentration at the processing point and in the vicinity of the processing point such that the cladding material is evenly melted, and moreover the base material is suppressed from melting too much, enabling a high-quality cladded article to be obtained.

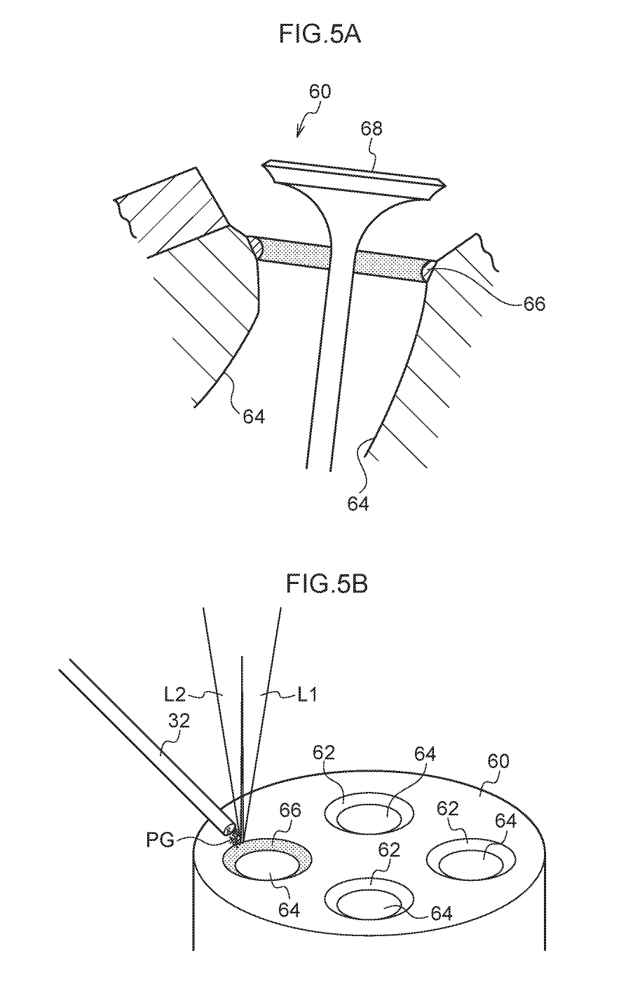

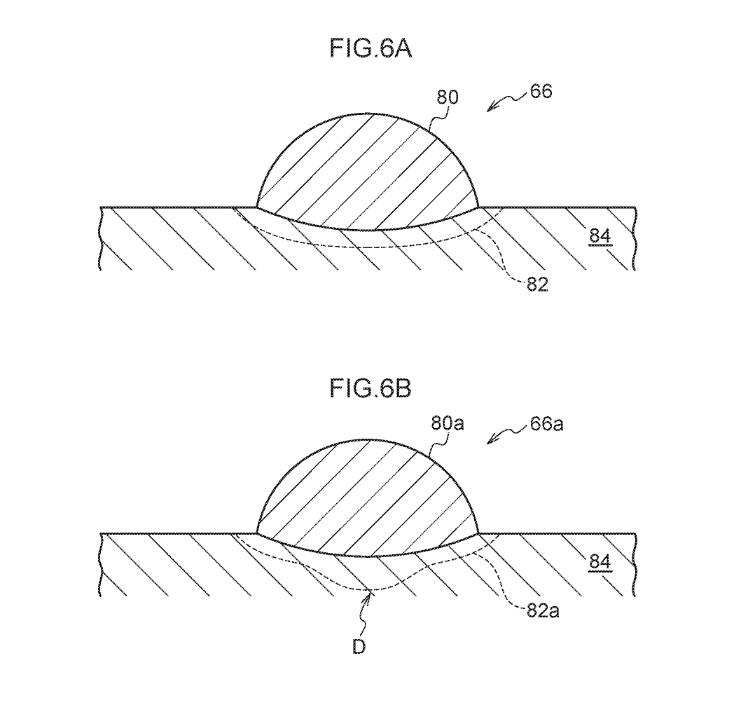

More detailed explanation follows regarding an example in which a cladding process using the laser processing device 10a is employed to form a valve seat of a cylinder head of an engine (internal combustion engine), with reference to FIG. 5A, FIG. 5B, FIG. 6A, and FIG. 6B. FIG. 5A is a cross-section of a cylinder head, and FIG. 5B is perspective view to explain the cladding process. FIG. 6A is a diagram illustrating a cross-sectional state of a cladded portion formed via this cladding process, and FIG. 6B is a comparative diagram illustrating a cross-sectional state of a cladded portion of related art.

As illustrated in FIG. 5A, a valve seat 66 formed via a cladding process is provided at the rim of a intake/exhaust valve hole 64 of a cylinder head 60 configuring part of an engine.

A valve 68 makes contact with and moves away from the valve seat 66 to take in and exhaust gas during engine operation. The valve seat 66 must therefore have a high degree of hardness, and both airtightness and wear resistance are required of the valve seat 66. The cladding process employing the laser processing device 10a according to the present exemplary embodiment is able to be suitably used to form a valve seat for which such properties are required.

As illustrated in FIG. 5B, the cylinder head 60 is, for example, provided with four intake/exhaust valve holes 64 (namely, a four-cylinder engine is illustrated in this example). A seat face 62 is formed at the rim of each intake/exhaust valve hole 64. A groove for forming the cladded portion may be provided on the seat face 62. In this example given for the present exemplary embodiment, the cylinder head 60 is formed from aluminum and the valve seat 66 is formed from copper. Note that the aluminum used to form the cylinder head 60 may be an aluminum alloy, and the copper used to form the valve seat 66 may be a copper alloy. The combination of metals is obviously not limited thereto, and other combinations of metals may be employed.

When performing the cladding process, as illustrated in FIG. 5B, a powder-mixed gas PG is ejected from the nozzle 32, and the beams of light L1, L2 are irradiated from the laser source 12 onto the metal powder (copper powder in the present exemplary embodiment) included in the powder-mixed gas PG Irradiating the beams of light L1, L2 onto the copper powder heats the copper powder, which is melted and sintered to form a copper cladded portion on the seat face 62. The valve seat 66 is formed by forming the cladded portion around the rim of the intake/exhaust valve hole 64. The aluminum of the seat face 62 is similarly heated and melted due to the irradiation of the beams of light L1, L2 thereon, thus forming an alloy layer below the cladded portion. Note that in FIG. 5B, to avoid complexity, the nozzle 32 illustrated in FIG. 4A and FIG. 4B is illustrated in a simplified manner limited to the metal powder/conveyance gas flow path 34.

Explanation follows regarding the cross-section structure of a valve seat 66 formed using the laser processing device 10a according to the present exemplary embodiment, with reference to FIG. 6A and FIG. 6B.

FIG. 6A illustrates the cross-section structure of a copper valve seat 66 formed on an aluminum base material 84 using the laser processing device 10a. As illustrated in FIG. 6A, the valve seat 66 includes a cladded portion 80, and below the cladded portion 80, the valve seat 66 is formed with a copper-aluminum-alloy layer (diluted layer) 82 that penetrates into the base material 84. This alloy layer 82 is formed at a location where heat is input by the laser source 12. The shape of the outline of the alloy layer 82 is substantially equal to that of the heat-affected zone.

As illustrated in FIG. 6A, the shape of the alloy layer 82 of the valve seat 66 according to the present exemplary embodiment is a simple depression (bowl shape) without any steps or the like. This is because in forming the valve seat 66, suppressing the energy density at the central portion of the spot S at the processing point and in the vicinity of the processing point has the effect of making the heat input distribution uniform at the processing point and in the vicinity of the processing point.

In contrast thereto, FIG. 6B illustrates a valve seat 66a formed on the base material 84 using a laser processing device according to related art. This valve seat 66a also includes a cladded portion 80a, and an alloy layer 82a is formed below the cladded portion 80a in the valve seat 66a.

As illustrated in FIG. 6B, the shape of the alloy layer 82a of the valve seat 66a differs from that of the alloy layer 82 of the valve seat 66, and includes a stepped portion D. As explained previously, this is because the energy density is comparatively high at a central portion of the beam spot of the laser processing device according to the related art, and so excessive heat is input to the central portion of the processing point. When such a stepped portion D due to excessive heat input is present, this portion of the alloy layer 82a becomes brittle. Since the alloy layer 82 of the valve seat 66 according to the present exemplary embodiment has a simple bowl shape that does not include a stepped portion D or the like, the occurrence of such an issue is suppressed.

Note that although in each of the above exemplary embodiments explanation was given using an example in which the optical element 14 is a wedge shaped optical element that includes left-right symmetric faces P1, P2, namely, an optical element with axial symmetry, there is no limitation thereto. The angles of incidence of collimated light L0 thereon may be modified in accordance with the required optical intensity distribution or the like. For example, configuration may be such that the ridge line R is offset from center (a configuration in which the angle between face P1 and the Z-axis differs from the angle between the face P2 and the Z-axis).

Further, although in each of the above exemplary embodiments explanation was given using an example in which the number of faces configuring the optical element 14 is two (P1, P2), there is no limitation thereto, and three or more faces may be employed in accordance with the required optical intensity distribution or the like. Further, the faces forming the optical element 14 are not limited to being wedge shaped, and a conical shape may be employed therefor. With an optical element 14 with a conical face, the optical intensity distribution at the central portion of a substantially circular spot S would be controlled to a substantially circular shape. Namely, this enables a ring shaped (annular) spot S to be obtained.

Further, although in each of the above exemplary embodiments explanation was given using an example in which the optical element 14 has a substantially circular profile, there is no limitation thereto, and in accordance with the required optical intensity distribution or the like, configuration may be such that the optical element 14 has another shape, for example, a rectangular shape or an elliptical shape.

Further, although in each of the above exemplary embodiments explanation was given using an example in which a unitary (bulk) wedge shaped optical element is employed as the optical element 14, there is no limitation thereto. For example, configuration may be such that a composite lens that combines plural lenses with differing curvatures is employed, or configuration may be such that an array of cylindrical lenses is employed.

The disclosure of Japanese Patent Application No. 2015-249409 is incorporated in its entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

1. A laser processing device comprising:
a laser source;
a collimator that collimates light generated by the laser source;
an optical element including a converter that converts the collimated light into a beam of light that includes a plurality of collimated lights which respectively have optical axes that are different from each other and that transmits the beam of light; and
a focusing element that focuses the beam of light onto a workpiece.

2. The laser processing device of claim 1, wherein:
the converter of the optical element has a wedge shape that has at least two faces, and the converter is disposed within the collimated light so that a ridge line of the wedge shape faces toward the laser source.

3. The laser processing device of claim 1, wherein:
the converter of the optical element has a conical shape, and the converter is disposed within the collimated light so that an apex of the conical shape faces toward the laser source.

4. The laser processing device of claim 1, further comprising:
a cladding section including a cladding material supply portion that supplies cladding material for a cladding process,
wherein the cladding section performs the cladding process by supplying the cladding material to the workpiece from the cladding material supply portion and irradiating the beam of light onto the supplied cladding material while the cladding material supply portion and the beam of light move relative to the workpiece.

5. The laser processing device of claim 4, wherein:
the cladding section performs the cladding process to form a valve seat of a cylinder head for an internal combustion engine.

6. An optical system comprising:
a collimator that collimates light generated by a light source;
an optical element that converts the collimated light into a beam of light that includes a plurality of collimated lights that respectively have optical axes that are different from each other and that transmits the beam of light; and
a focusing element that focuses the beam of light.

7. A laser processing method comprising:
collimating light generated by a laser source using a collimator;
converting the collimated light into a beam of light that includes a plurality of collimated lights that respectively have optical axes that are different from each other, and transmitting the beam of light, using an optical element; and
focusing the beam of light onto a workpiece using a focusing element.

8. The laser processing method of claim 7, further comprising:
using a cladding section including a cladding material supply portion that supplies cladding material for a cladding process, and performing the cladding process by supplying the cladding material to the workpiece from the cladding material supply portion while moving the cladding material supply portion and the beam of light relative to the workpiece and irradiating the beam of light onto the supplied cladding material.

9. A cladded workpiece comprising:
a base material that is composed of a first metal;
a cladded portion that is formed on the base material using a second metal; and
an alloy portion that is disposed between the base material and the cladded portion, where the base material and the cladded portion are melted and bonded together, wherein:
a bonding face between the base material and the alloy portion is bowl shaped, and
the cladded portion and the alloy portion are formed via a cladding process in which, in a case in which a cladding material is supplied to the base material, collimated light obtained from light generated by a laser source is converted by an optical element into a beam of light that includes a plurality of collimated lights that respectively have optical axes that are different from each other, the beam of light is focused onto a workpiece by a focusing element, and the beam of light is irradiated onto the supplied cladding material.
